(19) United States
(12) Patent Application Publication
(10) Pub. No.: US 2023/0065703 A1
(43) Pub. Date: Mar. 2, 2023

(54) TORSION SENSOR AND JOINT ACTUATOR OF ROBOT

(71) Applicant: Coretronic Corporation, Hsin-Chu (TW)

(72) Inventors: Shih-Wei Liu, Hsin-Chu (TW); Chi-Tang Hsieh, Hsin-Chu (TW); Yung-Yu Chang, Hsin-Chu (TW); Kuang-Yao Liu, Hsin-Chu (TW); Ming-Ju Chang, Hsin-Chu (TW)

(73) Assignee: Coretronic Corporation, Hsin-Chu (TW)

(21) Appl. No.: 17/878,902

(22) Filed: Aug. 1, 2022

(30) Foreign Application Priority Data
Aug. 27, 2021 (CN) 202122036412.9

(51) Int. Cl. B25J 9/16

(52) U.S. Cl. CPC B25J 9/1633

(57) ABSTRACT

A torsion sensor, configured to sense torque generated or received by a joint actuator, is provided. The torsion sensor includes an inner ring, an outer ring, multiple radial bridging portions, multiple overload structures, and multiple strain sensing units. The inner ring and the outer ring are disposed on the same axis and are separated from each other. The torque enables the inner ring and the outer ring to relatively rotate with reference to the axis. The radial bridging portions are disposed at intervals and each radial bridging portion is connected between the inner ring and the outer ring along a radial direction, and each radial bridging portion has at least one depression. Each overload structure extends from the inner ring toward the outer ring along the radial direction and has at least one gap with the outer ring. The strain sensing units are respectively disposed on the radial bridging portions.

### CROSS-REFERENCE TO RELATED APPLICATION

This application claims the priority benefit of China application serial no. 202122036412.9, filed on Aug. 27, 2021. The entirety of the above-mentioned patent application is hereby incorporated by reference herein and made a part of this specification.

### BACKGROUND

### Technical Field

The disclosure relates to a torsion sensor and an actuator, and in particular to a torsion sensor and a joint actuator of a robot.

### Description of Related Art

The industrial robot can not only overcome the impact of harsh environments on production and reduce manpower, but also improve production efficiency and ensure product quality. With the continuous development of industrial robot technology, the industrial robot no longer only has the function of transporting heavy objects, but can also perform various high-precision intelligent tasks, such as welding, precision assembly, grinding, and other actions.

Focusing on the joint actuator of the industrial robot, special attention is paid to the control of forces of the robot and feedback. Therefore, it is inevitable to add corresponding elements such as a torsion sensor or a strain gauge into the joint actuator. However, in the conventional torsion sensor or strain gauge, the structural rigidity is inversely proportional to the strain (torque) sensing capability. Therefore, how to obtain better results has become a topic to ponder for persons skilled in the art.

The information disclosed in this Background section is only for enhancement of understanding of the background of the described technology and therefore it may contain information that does not form the prior art that is already known to a person of ordinary skill in the art. Further, the information disclosed in the Background section does not mean that one or more problems to be resolved by one or more embodiments of the invention was acknowledged by a person of ordinary skill in the art.

### SUMMARY

The disclosure provides a torsion sensor and a joint actuator of a robot. The torsion sensor can carry torques in stages with an overload structure, thereby improving structural rigidity and sensing precision.

The torsion sensor of the disclosure is disposed on the joint actuator and is configured to sense torque generated or received by the joint actuator. The torsion sensor includes an inner ring, an outer ring, multiple radial bridging portions, multiple overload structures, and multiple strain sensing units. The inner ring and the outer ring are both disposed with an axis as a center and are separated from each other, and the torque enables the inner ring and the outer ring to generate relative rotation with reference to the axis. The radial bridging portions are disposed at intervals and each radial bridging portion is connected between the inner ring and the outer ring along a radial direction, and each radial bridging portion has at least one depression. The overload structures respectively extend from the inner ring toward the outer ring along the radial direction, and there is at least one gap between each overload structure and the outer ring. The strain sensing units are respectively disposed on the radial bridging portions. When the torque is less than a preset value, the overload structure and the outer ring maintain the gap. When the torque is greater than or equal to the preset value, the overload structure abuts the outer ring.

The joint actuator of the robot of the disclosure includes a drive device, a drive shaft, a reducer, and a torsion sensor. The drive shaft is connected to the drive device, and the drive device is configured to drive the drive shaft to rotate. The reducer includes a power input member and a power output member, which are respectively sleeved on the drive shaft. The power input member is disposed between the drive shaft and the power output member. The torsion sensor includes an inner ring, an outer ring, multiple radial bridging portions, multiple overload structures, and multiple strain sensing units. The inner ring and the outer ring are disposed with an axis of the drive shaft as a center and are separated from each other, and the inner ring is locked to the power output member. The torsion sensor is configured to sense torque generated or received by the joint actuator, so that the inner ring and the outer ring generate relative rotation with reference to the axis. The radial bridging portions are disposed at intervals and each radial bridging portion is connected between the inner ring and the outer ring along a radial direction, and each radial bridging portion has at least one depression. The overload structures respectively extend from the inner ring toward the outer ring along the radial direction, and there is at least one gap between each overload structure and the outer ring. The strain sensing units are respectively disposed on the radial bridging portions. When the torque is less than a preset value, the overload structure and the outer ring maintain the gap. When the torque is greater than or equal to the preset value, the overload structure abuts the outer ring.

Based on the above, in the torsion sensor applied to the joint actuator of the robot, the overload structures are formed between the inner ring and the outer ring, and the overload structures extend from the inner ring toward the outer ring and have at least one gap with the outer ring to respond to the torque generated or received by the joint actuator. Furthermore, the overload structures enable the torsion sensor to withstand different torques in stages. When the torque is less than the preset value, the overload structure and the outer ring maintain the gap, and when the torque is greater than or equal to the preset value, the overload structure is enabled to move the gap to abut the outer ring, so as to further improve the overall structural rigidity of the torsion sensor with the structural abutment, thereby improving the sensing range and applicability of the torsion sensor.

Other objectives, features and advantages of the present invention will be further understood from the further technological features disclosed by the embodiments of the present invention wherein there are shown and described preferred embodiments of this invention, simply by way of illustration of modes best suited to carry out the invention.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic view of a joint actuator of a robot according to an embodiment of the disclosure.

FIG. 2 is a cross-sectional view of the joint actuator of FIG. 1.

FIG. 3A is a schematic view of a torsion sensor of the disclosure.

FIG. 3B is an enlarged schematic view of a radial bridging portion of the torsion sensor of FIG. 3A.

FIG. 4 is a front view of the torsion sensor of FIG. 3A.

FIG. 5 and FIG. 6 are schematic views showing load curves of a conventional torsion sensor and the torsion sensor of the embodiment.

### DETAILED DESCRIPTION OF DISCLOSED EMBODIMENTS

In the following detailed description of the preferred embodiments, reference is made to the accompanying drawings which form a part hereof, and in which are shown by way of illustration specific embodiments in which the invention may be practiced. In this regard, directional terminology, such as “top,” “bottom,” “front,” “back,” etc., is used with reference to the orientation of the Figure(s) being described. The components of the present invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the present invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component directly faces “B” component or one or more additional components are between “A” component and “B” component. Also, the description of “A” component “adjacent to” “B” component herein may contain the situations that “A” component is directly “adjacent to” “B” component or one or more additional components are between “A” component and “B” component. Accordingly, the drawings and descriptions will be regarded as illustrative in nature and not as restrictive.

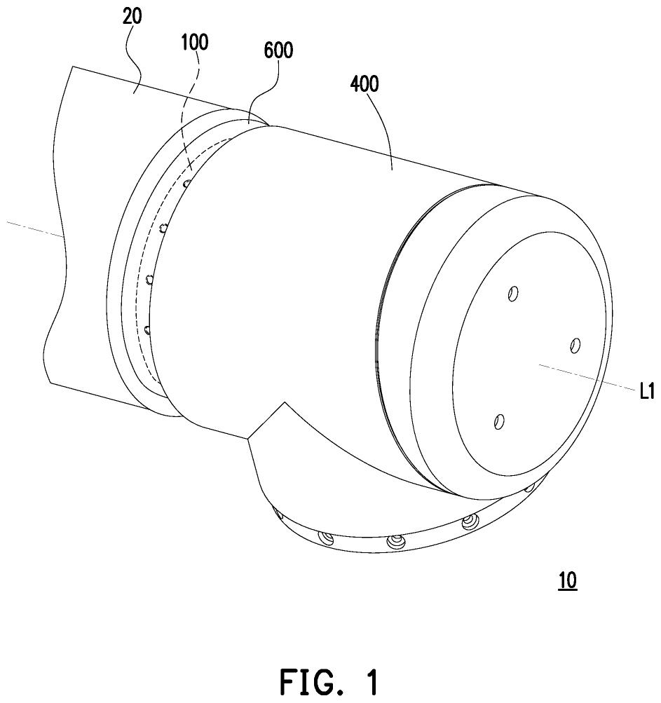

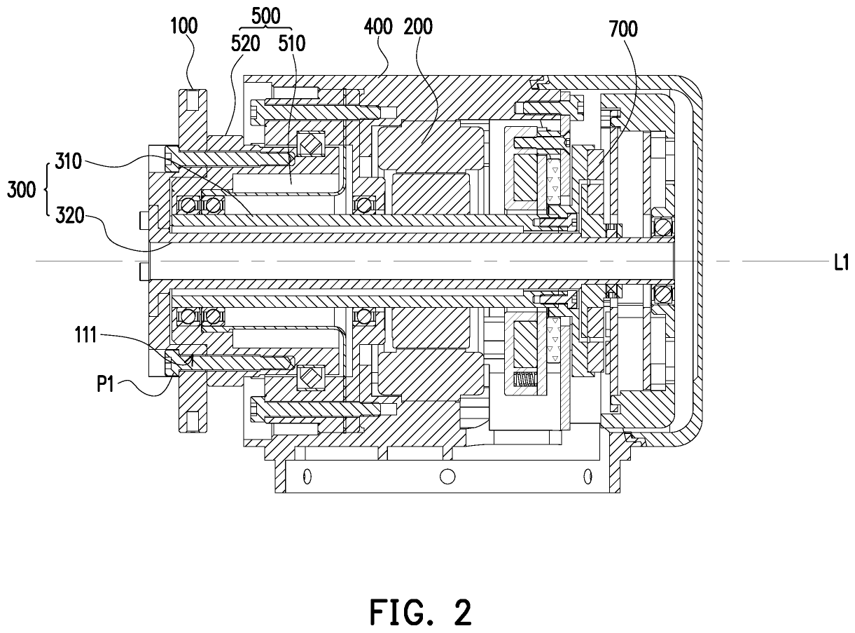

FIG. 1 is a schematic view of a joint actuator of a robot according to an embodiment of the disclosure. FIG. 2 is a cross-sectional view of the joint actuator of FIG. 1. Please refer to FIG. 1 and FIG. 2 at the same time. In the embodiment, a joint actuator 10 includes a drive device 200, a drive shaft 300, a reducer 500, a case 400, a dual encoder 700, and a torsion sensor 100. The drive shaft 300 is connected to the drive device 200. The drive device 200 is, for example, a frameless motor located between the dual encoder 700 and the reducer 500. The drive device 200 is configured to drive the drive shaft 300 to rotate. The drive device 200, the drive shaft 300, the reducer 500, and the dual encoder 700 are disposed in the case 400. The torsion sensor 100 is connected to the reducer 500. The dual encoder 700 is connected to the drive shaft 300. The torsion sensor 100, the reducer 500, the drive device 200, and the dual encoder 700 are sequentially sleeved on the drive shaft 300 along an axis L1.

The reducer 500 includes a power input member 510 and a power output member 520, which are respectively sleeved on the drive shaft 300. The power input member 510 is, for example, a hat-shaped flex spline. The power output member 520 is, for example, a rigid spline. The power input member 510 is disposed between the drive shaft 300 and the power output member 520. The torsion sensor 100 is connected to the power output member 520. The drive shaft 300 may be decelerated by a reduction ratio between the power input member 510 and the power output member 520. The specific structure design of the reducer 500 for achieving the reduction ratio is the prior art, which will not be repeated here.

In addition, the drive shaft 300 includes an input shaft 310 and an output shaft 320 that are coaxially disposed. The input shaft 310 is sleeved on the outside of the output shaft 320. The drive device 200 is, for example, connected to the input shaft 310 to drive the input shaft 310 to rotate with the axis L1 as a central axis. One end of the input shaft 310 is connected to the power input member 510 of the reducer 500 (equivalent to being connected to the drive device 200), and one end of the output shaft 320 is connected to the power output member 520. Furthermore, since the torsion sensor 100 is connected to the power output member 520 (for example, the rigid spline, an output end) as mentioned above instead of being connected to the power input member 510 (an internal unit), the structure design of the connection between the torsion sensor 100 and the reducer 500 may be simplified.

Based on the above, the joint actuator 10 of the embodiment may not only use the torsion sensor 100 to sense the force at the output end of the joint actuator 10, but also use the dual encoder 700 to sense the angular displacement of an input end and the output end of the joint actuator 10. Also, since the dual encoder 700 and the torsion sensor 100 are coupled to each other, and the aforementioned displacement sensing signal and force sensing signal may be integrated to accurately determine the force bearing state of the robot, thereby accurately performing a corresponding high-precision action.

Furthermore, as shown in FIG. 1, a mechanical arm 20 of the robot includes a connecting member 600. The torsion sensor 100 of the joint actuator 10 is connected to the mechanical arm 20 of the robot through the connecting member 600. Accordingly, an external force from the mechanical arm 20 is transmitted to the torsion sensor 100 through the connecting member 600, so that the torsion sensor 100 of the embodiment can also sense the torque corresponding to the external force.

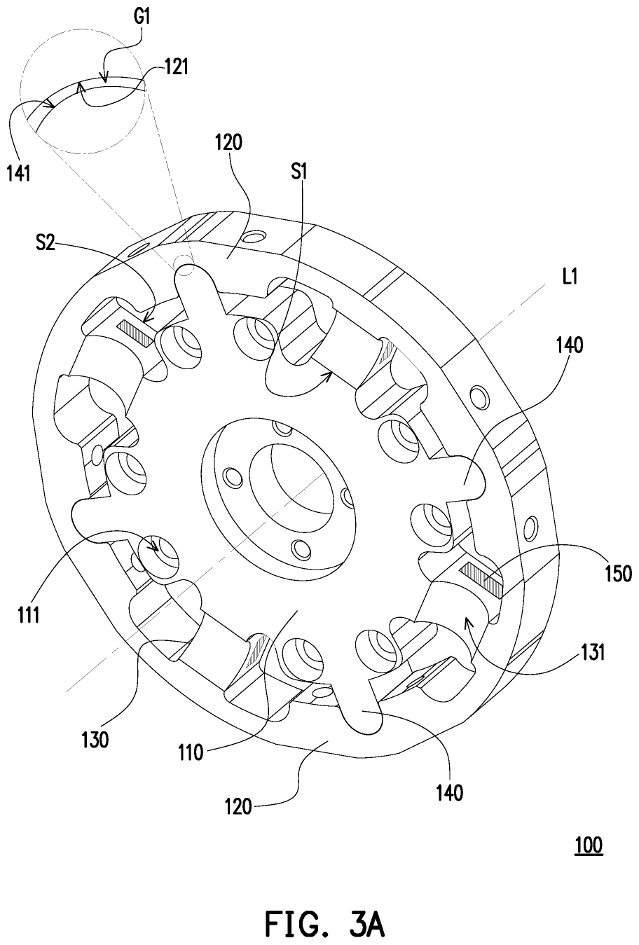

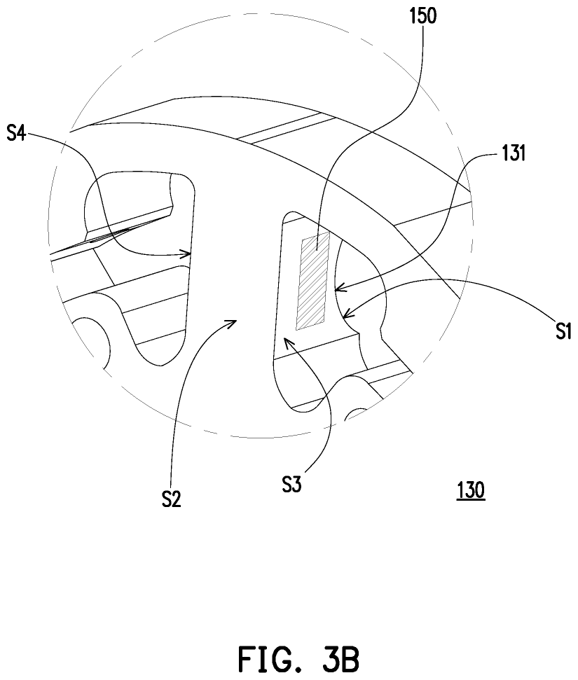

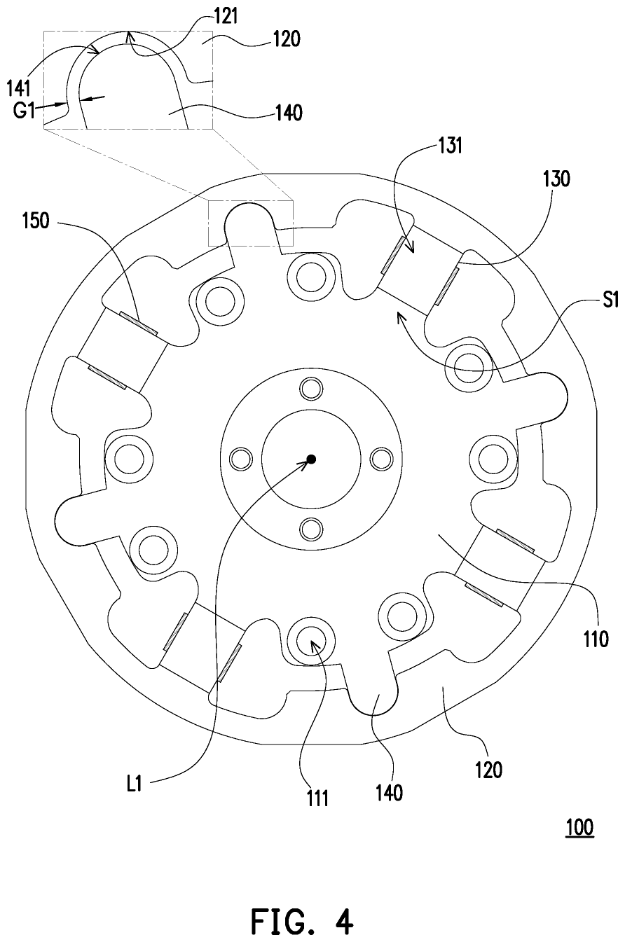

FIG. 3A is a schematic view of a torsion sensor of the disclosure. FIG. 3B is an enlarged schematic view of a radial bridging portion of the torsion sensor of FIG. 3A (back side). FIG. 4 is a front view of the torsion sensor of FIG. 3A. Please refer to FIG. 2 to FIG. 4 at the same time. In the embodiment, the torsion sensor 100 is a monolithic disk-shaped mount, which includes an inner ring 110, an outer ring 120, multiple radial bridging portions 130 (e.g., spoke), multiple overload structures 140, and multiple strain sensing units 150. The inner ring 110 and the outer ring 120 are two concentric rings separated from each other and are disposed with the axis L1 of the drive shaft 300 as the center. The inner ring 110 is locked to the power output member 520 of the reducer 500 by a locking member P1 (as shown in FIG. 2) in conjunction with a locking hole 111 of the inner ring 110 thereof. The outer ring 120 is connected to the mechanical arm 20 of the robot. The torsion sensor 100 is configured to sense the torque generated or received by the joint actuator 10, so that the inner ring 110 and the outer ring 120 generate relative rotation with reference to the axis L1. The radial bridging portions 130 are disposed at intervals around the axis L1 of the drive shaft 300, and each radial bridging portion 130 extends from the inner ring 110 to the outer ring 120 along a radial direction (away from the drive shaft 300 and the axis L1) and is connected between the inner ring 110 and the outer ring 120. In more detail, two ends of each radial bridging portion 130 are respectively connected to the inner ring 110 and the outer ring 120.

Each radial bridging portion 130 has at least one depression 131. The overload structures 140 respectively extend from the inner ring 110 toward the outer ring 120 along the radial direction, and there is at least one gap G1 between each overload structure 140 and the outer ring 120. The strain sensing units 150 are respectively disposed on the radial bridging portions 130. When the torque is less than a preset value, the overload structure 140 and the outer ring 120 maintain the gap G1. When the torque is greater than or equal to the preset value, the overload structure 140 abuts the outer ring 120.

Furthermore, since the inner ring 110 and the outer ring 120 perform relative rotation (which may also be regarded as twisting) with reference to the axis L1, the gap G1 is substantially present in a tangential direction of the relative rotation (e.g., a tangential direction of rotation direction or rotation path). It should be noted that the overload structure 140 and the inner ring 110 of the embodiment are, for example, an integral structure. The outer ring 120 has a concave portion 121 corresponding to the overload structure 140, and each concave portion 121 is formed by concaving from an inner wall of the outer ring 120 toward a direction away from an axial center (e.g., the axis L1) along the radial direction. The inner wall of the outer ring 120 faces the inner ring 110. Each overload structure 140 has a protruding portion 141 extending toward the direction away from the axial center along the radial direction, and the protruding portions 141 of the overload structures 140 are respectively located in the concave portions 121 of the outer ring 120. When the inner ring 120 and the outer ring 110 generate relative rotation with reference to the axis L1, a partial structure of the outer ring 120 is located on a movement path of the overload structure 140. In other words, the overload structure 140 (e.g., the protruding portions 141) and the outer ring 120 (e.g., the concave portions 121) of the embodiment form a seemingly complementary contour based on the relative rotation, so that the two can abut each other in the tangential direction during rotation (when the torque is greater than or equal to the preset value). In other embodiments, the overload structure 140 and the inner ring 110 are, for example, two independent structures that are combined through tight fitting, locking, bonding, or other ways, so that the overload structure 140 and the outer ring 120 maintain the gap G1.

Furthermore, when the torque is greater than or equal to the preset value such that the protruding portion 141 of the overload structure 140 abuts the concave portion 121 of the outer ring 120, the rigidity of the overload structure 140 is greater than the rigidity of the radial bridging portion 130 (i.e., the overload structure 140 is not a stopper), so that for the torsion sensor 100 in such state, the overload structure 140 abuts the outer ring 120 to bear the main torque force, thereby improving the load capacity and reliability of the torsion sensor 100, and preventing the strain sensing unit 150 at the radial bridging portion 130 from failing due to the inability to load excessive torque.

On the other hand, each radial bridging portion 130 of the embodiment has a first surface S1 and a second surface S2 opposite to each other in the direction of the axis L1. The depression 131 is located on the first surface S1 or the second surface S2 (the depression 131 of the embodiment is located on the first surface S1). The depression 131 causes each radial bridging portion 130 to have a minimum thickness along the axis L1. As such, the radial bridging portion 130 can generate significant strain, which is conducive to improve the sensing sensitivity of the strain sensing unit 150 disposed thereon. In more detail, each strain sensing unit 150 is disposed adjacent to the depression 131. For example, each radial bridging portion 130 has two side surfaces S3 and S4 (as shown in FIG. 3B) connecting the first surface S1 and the second surface S2, and the strain sensing unit 150 is disposed on the two side surfaces S3 and S4 or one of the two side surfaces and is located beside the depression 131. In the embodiment, each depression 131 is located at the center of the corresponding radial bridging portion 130 (e.g., the center of the first surface S1 of the radial bridging portion 130). In other embodiments, the depression 131 may also be disposed at a non-center of the corresponding radial bridging portion 130, such as being disposed closer to the outer ring 120 or closer to the inner ring 110.

Of course, in another embodiment that is not shown but may refer to FIG. 2 and FIG. 3 of the embodiment, each radial bridging portion 130 has the first surface S1 and the second surface S2 opposite to each other in the direction of the axis L1, and each radial bridging portion 130 has a pair of depressions 131 which are respectively located on the first surface S1 and the second surface S2 of each radial bridging portion 130. It should be noted that the designer may adjust the shape and degree of the depression 131 (that is, the thickness of the radial bridging portion 130 along the direction of the axis L1) according to the output requirements or usage environment of the joint actuator 10, so that the torsion sensor 100 can have both the required structural rigidity and sensing capability.

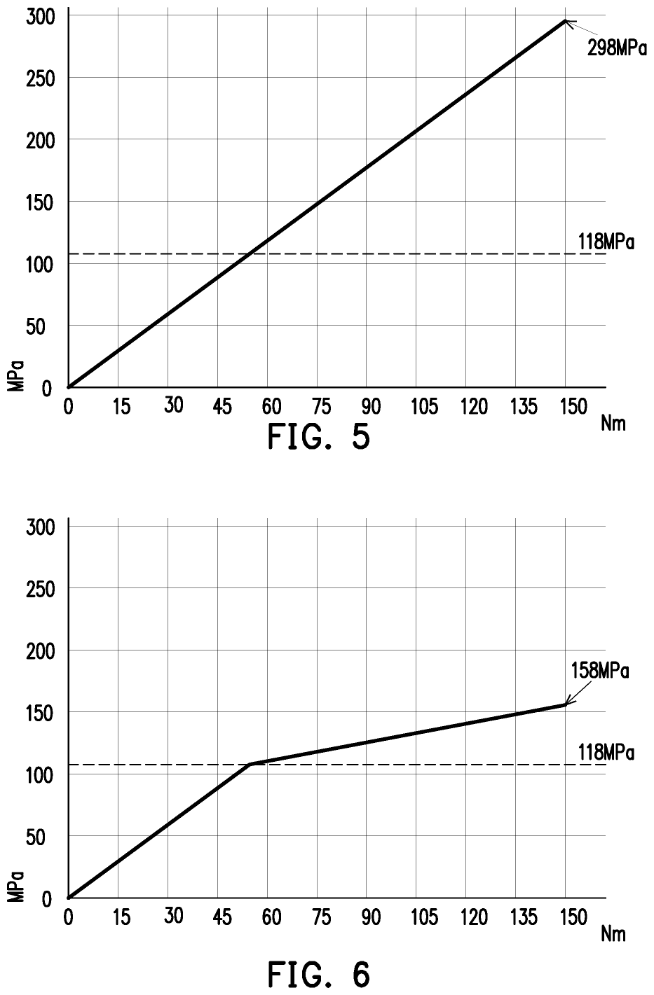

FIG. 5 and FIG. 6 are schematic views showing load curves of a conventional torsion sensor and the torsion sensor of the embodiment. FIG. 5 shows the conventional torsion sensor, and FIG. 6 shows the torsion sensor 100 of the embodiment. In the drawings, the horizontal axis represents the applied (or received) torque (in unit Nm), and the vertical axis is the maximum structural stress (in unit MPa) generated by the corresponding torque on the torsion sensor. Comparing FIG. 5 and FIG. 6, it can be clearly seen that due to the presence of the overload structures 140, when the torque is greater than or equal to the preset value (which is 118 MPa here), the torsion sensor 100 of the embodiment still has sufficient structural rigidity as support. Therefore, as shown in FIG. 6, when the torque is close to 150 Nm, the corresponding structural stress is 158 MPa. In contrast, as shown in FIG. 5, the conventional torsion sensor does not have the overload structures 140, so when the torque is also close to 150 Nm, a structural stress up to 298 MPa can be generated thereon. Therefore, the effect of the overload structures 140 adopted in the embodiment can be clearly understood.

In summary, in the torsion sensor applied to the joint actuator of the robot according to the embodiments of the disclosure, the overload structures are formed between the inner ring and the outer ring, and the overload structures extend from the inner ring toward the outer ring and have at least one gap with the outer ring to respond to the torque generated or received by the joint actuator.

In the embodiment, the overload structure has the protruding portion extending from the inner ring, and the outer ring has the corresponding depression. Therefore, when the inner ring and the outer ring generate relative rotation, the protruding portion and the depression abut in the tangential direction. Furthermore, the overload structures enable the torsion sensor to withstand different torques in stages. When the torque is less than the preset value, the overload structure and the outer ring maintain the gap, and when the torque is greater than or equal to the preset value, the overload structure moves the gap and abuts the outer ring, so that the torque at this time can be evenly distributed on the inner ring and the outer ring.

In this way, for the radial bridging portion, since the overload structure is used to bear the main torque when the torque exceeds the preset value as mentioned above, the strain sensing unit disposed on the radial bridging portion can smoothly measure the strain of the radial bridging portion without worrying about failure due to excessive load.

The above characteristics enable the torsion sensor of the disclosure to further improve the overall structural rigidity, sensing capability, and applicability.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. Moreover, these claims may refer to use “first”, “second”, etc. following with noun or element. Such terms should be understood as a nomenclature and should not be construed as giving the limitation on the number of the elements modified by such nomenclature unless specific number has been given. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. A torsion sensor, wherein the torsion sensor is disposed in a joint actuator, is configured to sense a torque generated or received by the joint actuator, and comprises an inner ring, an outer ring, a plurality of radial bridging portions, a plurality of overload structures, and a plurality of strain sensing units, wherein:
the inner ring and the outer ring are disposed with a same axis as a center and are separated from each other, and the inner ring and the outer ring to generate relative rotation with reference to the axis due to the torque;
the plurality of radial bridging portions are disposed at intervals and each of the plurality of radial bridging portions is connected between the inner ring and the outer ring along a radial direction, and each of the plurality of radial bridging portions has at least one depression;
the plurality of overload structures respectively extend from the inner ring toward the outer ring along the radial direction, and there is at least one gap between each of the plurality of overload structures and the outer ring; and
the plurality of strain sensing units are respectively disposed on the plurality of radial bridging portions,
wherein when the torque is less than a preset value, the plurality of overload structures and the outer ring maintain the gap, and when the torque is greater than or equal to the preset value, the plurality of overload structures abut the outer ring.

2. The torsion sensor according to claim 1, wherein the gap is located in a tangential direction of the relative rotation.

3. The torsion sensor according to claim 1, wherein when the plurality of overload structures abut the outer ring, a rigidity of the torsion sensor at the plurality of overload structures is greater than a rigidity of the torsion sensor at the plurality of radial bridging portions.

4. The torsion sensor according to claim 1, wherein each of the plurality of radial bridging portions has a first surface and a second surface opposite to each other in a direction of the axis, and the depression is located on the first surface or the second surface.

5. The torsion sensor according to claim 1, wherein each of the plurality of radial bridging portions has a first surface and a second surface opposite to each other in a direction of the axis, and each of the plurality of radial bridging portions has a pair of depressions, which are respectively located on the first surface and the second surface of each of the plurality of radial bridging portions.

6. The torsion sensor according to claim 1, wherein the outer ring has a plurality of concave portions corresponding to the plurality of overload structures, each of the plurality of overload structures has a protruding portion along the radial direction, and the plurality of protruding portions of the plurality of overload structures are respectively located in the plurality of concave portions of the outer ring.

7. The torsion sensor according to claim 1, wherein when the inner ring and the outer ring generate relative rotation with reference to the axis, a partial structure of the outer ring is located on a movement path of the overload structure.

8. The torsion sensor according to claim 1, wherein the plurality of overload structures and the inner ring are an integral structure or the plurality of overload structures and the inner ring are two independent structures.

9. The torsion sensor according to claim 1, wherein the plurality of strain sensing units are respectively disposed beside the plurality of depressions of the plurality of radial bridging portions, and each of the plurality of depressions enables each of the plurality of radial bridging portions to have a minimum thickness along the axis.

10. The torsion sensor according to claim 1, wherein the torsion sensor is a monolithic disk-shaped mount.

11. A joint actuator of a robot, comprising a drive device, a drive shaft, a reducer, and a torsion sensor, wherein:
the drive shaft is connected to the drive device, and the drive device is configured to drive the drive shaft to rotate;
the reducer comprises a power input member and a power output member, which are respectively sleeved on the drive shaft, wherein the power input member is disposed between the drive shaft and the power output member; and
the torsion sensor comprises an inner ring, an outer ring, a plurality of radial bridging portions, a plurality of overload structures, and a plurality of strain sensing units, wherein:
the inner ring and the outer ring are disposed with a same axis of the drive shaft as a center and are separated from each other, the inner ring is locked to the power output member, and the torsion sensor is configured to sense a torque generated or received by the joint actuator, so that the inner ring and the outer ring generate relative rotation with reference to the axis;
the plurality of radial bridging portions are disposed at intervals and each of the plurality of radial bridging portions is connected between the inner ring and the outer ring along a radial direction, and each of the plurality of radial bridging portions has at least one depression;
the plurality of overload structures respectively extend from the inner ring toward the outer ring along the radial direction, and there is at least one gap between each of the plurality of overload structures and the outer ring; and
the plurality of strain sensing units are respectively disposed on the plurality of radial bridging portions, wherein when the torque is less than a preset value, the plurality of overload structures and the outer ring maintain the gap, and when the torque is greater than or equal to the preset value, the plurality of overload structures abut the outer ring.

12. The joint actuator of the robot according to claim 11, wherein the gap is located in a tangential direction of the relative rotation.

13. The joint actuator of the robot according to claim 11, wherein when the plurality of overload structures abut the outer ring, a rigidity of the torsion sensor at the plurality of overload structures is greater than a rigidity of the torsion sensor at the plurality of radial bridging portions.

14. The joint actuator of the robot according to claim 11, wherein each of the plurality of radial bridging portions has a first surface and a second surface opposite to each other in a direction of the axis, and the depression is located on the first surface or the second surface.

15. The joint actuator of the robot according to claim 11, wherein each of the plurality of radial bridging portions has a first surface and a second surface opposite to each other in a direction of the axis, and each of the radial bridging portions has a pair of depressions, which are respectively located on the first surface and the second surface of each of the plurality of radial bridging portions.

16. The joint actuator of the robot according to claim 11, wherein the outer ring has a plurality of concave portions corresponding to the plurality of overload structures, each of the plurality of overload structures has a protruding portion along the radial direction, and the plurality of protruding portions of the plurality of overload structures are respectively located in the plurality of concave portions of the outer ring.

17. The joint actuator of the robot according to claim 11, wherein when the inner ring and the outer ring generate relative rotation with reference to the axis, a partial structure of the outer ring is located on a movement path of the overload structure.

18. The joint actuator of the robot according to claim 11, wherein the overload structure and the inner ring are an integral structure.

19. The joint actuator of the robot according to claim 11, wherein the plurality of strain sensing units are respectively disposed beside the plurality of depressions of the plurality of radial bridging portions, and each of the plurality of depressions enables each of the plurality of radial bridging portions to have a minimum thickness along the axis.

20. The joint actuator of the robot according to claim 11, wherein the torsion sensor is a monolithic disk-shaped mount.
